(19) United States
(12) Patent Application Publication
(10) Pub. No.: US 2006/0245049 A1
(43) Pub. Date: Nov. 2, 2006

(54) Scanning microscope

(76) Inventor: Werner Knebel, Kronau (DE)

Correspondence Address: SIMPSON & SIMPSON, PLLC, 5555 MAIN STREET, WILLIAMSVILLE, NY, 14221-5406, US

(21) Appl. No.: 10/565,615

(22) PCT Filed: Jul. 26, 2004
(86) PCT No.: PCT/EP04/51606

§ 371 Date: Jun. 15, 2006

(30) Foreign Application Priority Data
Jul. 26, 2003 (DE) 103341455

(51) Int. Cl. G02B 21/06

(52) U.S. Cl. 359/385; 359/368

(57) ABSTRACT

The invention relates to a scanning microscope with a light source, defining an illumination light beam, and a spectral detector for detection of the detection light coming from the sample, which defines a detection beam and which contains a spectral splitter component. The scanning microscope is characterized in that the spectral splitting component separates the illumination and the detection beams.

The invention relates to a scanning microscope with at least one light source defining an illumination light beam, and with a spectral detector for detecting the detection light coming from the sample and defining a detection light beam, and which contains a spectral splitter component.

In scanning microscopy a sample is illuminated with a light beam to be able to observe the reflected light or fluorescent light emitted by the sample. The focus of an illumination light beam is moved in an objective plane with the aid of a controllable beam deflection device, generally by tilting two mirrors, the deflection axes in most cases being perpendicular to one another so that one mirror deflects the light in the X-direction and the other mirror deflects it in the Y-direction. The tilting of the mirrors is brought about with the aid of, for example, galvanometer positioning elements. The power of the light coming from the object is measured as a function of the position of the scanning beam. Usually, the positioning elements are equipped with sensors for determining the current mirror position.

In confocal scanning microscopy, in particular, an object is scanned in three dimensions with the focus of a light beam.

A confocal scanning microscope comprises in general a light source, focusing optics with which the light from the source is focused on a pinhole known as the excitation pinhole, a beam splitter, a beam deflection device for beam control, microscope optics, a detection aperture and the detectors for detecting the detecting light and the fluorescent light. The illumination light is often coupled in via a beam splitter configured, for example, as a neutral beam splitter or as a dichroic beam splitter. Neutral beam splitters have the drawback that much excitation light or much detection light is lost, depending on the splitting ratio.

The fluorescent light or the reflected light coming from the object proceeds via the beam deflection device back to the beam splitter, passes said beam splitter and is then the focused on the detection aperture behind which the detectors are located. Detection light that does not stem directly from the focal region takes another pathway and does not pass through the detection aperture so that point information is obtained which by sequential scanning of the object leads to a tridimensional image. In most cases, a tridimensional image is obtained by layerwise image data acquisition, with the path of the scanning light beam ideally describing a meander on or in the object. (Scan one line in the X-direction at constant Y-position, then maintain the X-scanning and by Y-displacement switch to the next line to be scanned, and then, at a constant Y-position, scan this line in the negative X-direction etc). To permit image data acquisition in layers, after the scanning of a layer the specimen stage or the objective is displaced and the next layer to be scanned is brought into the focal plane of the objective.

In many applications, the samples are prepared with several markers, for example with several different fluorescent dyes. These dyes can be excited sequentially, for example with illumination light beams having different excitation wavelengths. Simultaneous excitation with an illumination light beam containing light of different excitation wavelengths is common. For example, European patent application EP 0 495 930, “Confocal Microscope System for Multicolor Fluorescence”, discloses an arrangement with a single laser emitting several laser lines. In current practice, most such lasers are mixed gas lasers, particularly Ar—Kr lasers.

Multiband detectors are often used for the simultaneous detection of the detection light coming from the sample. From Unexamined German Patent Application DE 4330347 A1 is known a system for the selection and detection of at least two spectral ranges of a light beam with a selection device and a detection device. For the purpose of reliable simultaneous selection and detection of different spectral ranges with high yields and to ensure very simple construction, the system is configured in such a way that the selection device comprises a component for spectral splitting of the light beam for example a prism or a grating and means for, on the one hand, blocking out a first spectral range and, on the other, to reflect at least part of the non-blocked out spectral range, and the detection device comprises a first detector disposed in the light beam path of the blocked out first spectral range and a second detector in the light beam path of the reflected spectral range. The means for blocking out a first spectral range and, on the other hand, to reflect at least part of the non-blocked out spectral range is preferably a strip aperture device with mirrored aperture sides. In particular, the system can be used as a multiband detector in a scanning microscope.

From German Unexamined Patent Application DE 198 42 288 A1 is known a system for adjustable coupling in and/or detection of one or more wavelengths in a microscope. The system consists of at least one dispersive element for wavelength separation of the illumination light and of at least one partly reflective element for back reflecting at least one wavelength range in the direction of the microscope illumination, said reflective element being disposed in the wavelength separated part of the illumination light. In addition, for adjustable detection in the wavelength separated part of the object light there are provided means for adjustable blocking out at least one wavelength range and means for deflecting the blocked out wavelength range in the direction of a detector. Last but not least, because of the variability relative to the wavelength range to be blocked out, the construction of the system is expensive and complicated.

From patent document DE 195 10 102 C1 is known a semiconfocal fluorescence microscope wherein the illumination light from a light source is spectrally split with the aid of a spectrometer system and is guided to a sample via a wavelength selection aperture and another spectrometer system for strip shaped illumination. The detection light coming from the sample is spectrally separated by the other spectrometer system and is guided to a detector system via a wavelength selection aperture and a third spectrometer system after passign through a strip aperture. The wavelength selection aperture is disposed slidably for the purpose of setting the wavelength ranges in question. Because of the fact that at least three spectrometer systems are needed, in particular, this arrangement is expensive to fabricate and difficult to adjust.

It is the object of the present invention to propose a scanning microscope which while simple to fabricate permits both the in coupling of the illumination light preferably of several wavelengths and the detection of the detection light in several wavelength ranges.

This object is achieved by way of a scanning microscope characterized in that the spectral splitter component separates the illumination beam and the detection beam.

The invention has the advantage that a component present in many types of devices, namely the component for spectrally splitting the detection light, is used at the same time for in coupling the illumination light, as a result of which the use of other expensive components complicating the beam path are to a large extent avoided. Advantageously, in the scanning microscope of the invention the spectral splitter component takes over the function of the main beam separator, namely the separation of the illumination beam and the detection beam, so that the problems arising in main beam separators based on neutral beam separators, namely the enormous losses of light power, do not occur.

In a particular embodiment, the spectral splitter component is configured as a grating which, on the one hand, receives the illumination light guiding it further to the sample and, on the other, spectrally splits the light coming from the sample by diffraction and guides it to the detectors.

In a preferred embodiment of the scanning microscope, the spectral splitter component is configured as a prism.

Preferably, one boundary surface of the prism is at least partly reflectively coated. In a particular embodiment, the detection light to be spectrally split passes through the prism and in so doing is reflected at the reflectively coated parts of the boundary surface. Next to or between the reflectively coated parts of the boundary surface, there is provided no antireflective coating or preferably one such coating whereby the illumination light is coupled in.

In another variant, the illumination light strikes the reflectively coated parts of the boundary surface while the detection light strikes the uncoated or antireflectively coated parts of the boundary surface.

In a preferred embodiment, the reflectively coated parts of the boundary surface and the not reflectively coated parts of the boundary surface are disposed alternately next to each other. According to the invention, here use is made of the fact that, because of the Stokes shift, in the case of fluorescing samples the wavelength of the illumination light is spectrally shifted toward the detection light wavelength, for example by displacement of the prism along the boundary surface and perpendicular to the splitting direction of the detection light, making it possible to set the illumination/detection wavelength ranges. In a particularly preferred embodiment, to achieve a particularly stable, compact and simple design, the spectral splitter component is disposed in stationary manner. As a result, the number and the wavelength of the illumination lines to be used are unchangeable which, however, is sufficient for most microscopic uses.

By shifting the illumination light beam or beams relative to the coated or uncoated parts of the boundary surface, light power control can readily be accomplished. To this end, the illumination light beam or beams are laterally cut.

Preferably, the parts of the boundary surface through which the illumination light is coupled in are about 100 μm wide. The ratio of the widths of the parts of the boundary surface through which the detection light reaches the detectors to the parts of the boundary surface through which the illumination light is coupled in is preferably as large as possible to prevent small gaps in the detection spectrum.

In another particularly preferred embodiment variant, either the detection light or the illumination light are totally internally reflected. In this variant, no reflective coating is needed. To this end, the boundary surface of the prism is preferably structured in a stepped or sawtooth manner so that, for example, the detection light strikes the boundary surface at an angle causing total internal reflection, whereas the illumination light strikes at an angle that permits transmission. The opposite is, of course, also possible, namely that the illumination light is totally internally reflected, while the detection light is transmitted.

In another variant, the boundary surface is provided with segments made of a material with a refractive index different from that of the prism. A configuration is thus created in simple manner in which regions of the boundary surface with total internal reflection and regions not showing total internal reflection are disposed side by side.

In a preferred embodiment, the illumination light contains, for example, three selected laser lines (for example, 488 nm, 560 nm and 633 nm or any other combination which preferably is definitely predetermined). These lines are coupled into the prism through the coated boundary surface at an appropriate angle in a manner collinear with the detection light beam. The illumination light beam path then proceeds in the opposite direction, passes the illumination and detection pinhole (which in this variant are identical), reaches the beam deflection unit and is guided via the tube lens and scanning lens through the object to the sample.

Illumination light with four or more laser lines can also be used which is not possible, for example, with scanning microscopes based on beam splitters. This is because there are currently no multichroic beam splitters whereby illumination light with four or more laser lines can be simultaneously coupled into a microscope.

According to the invention, the coupling in of illumination light with a wavelength of 532 nm is advantageously also made possible, which is also not possible with current beam splitters, because the 532 nm line is too close to the Ar lines.

Preferably, the spatial width of the split detection light at the boundary surface is about 1 cm which corresponds to a spectral width of about 400 nm. Hence, by the 100 μm wide uncoated or antireflectively coated coupling in, slits of only 4 nm are cut out from the detection spectrum, which is acceptable for most uses. Moreover, reflected illumination light returns through the same boundary surface back to the laser and is thus advantageously coupled out of the detection light beam.

Also conceivable is the use of other prisms or other types of prisms in which the spatial spectral splitting at the boundary surface is greater so that the illumination light does not have to be focused so strongly onto the nonreflecting parts, namely the coupling-in slits, of the boundary surface.

In a particularly preferred embodiment, the scanning microscope is configured as a confocal scanning microscope.

In the drawing, the object of the invention is represented schematically and in the following is described with reference to the figures in which components exerting the same action are indicated by the same reference numerals and of which:

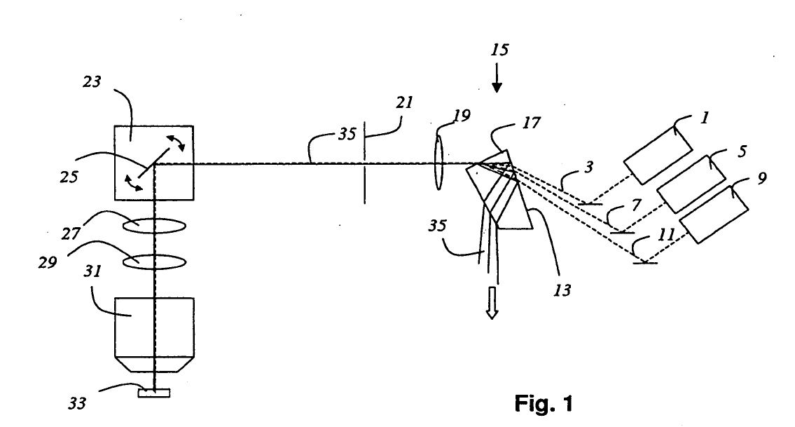

FIG. 1 shows a scanning microscope of the invention,

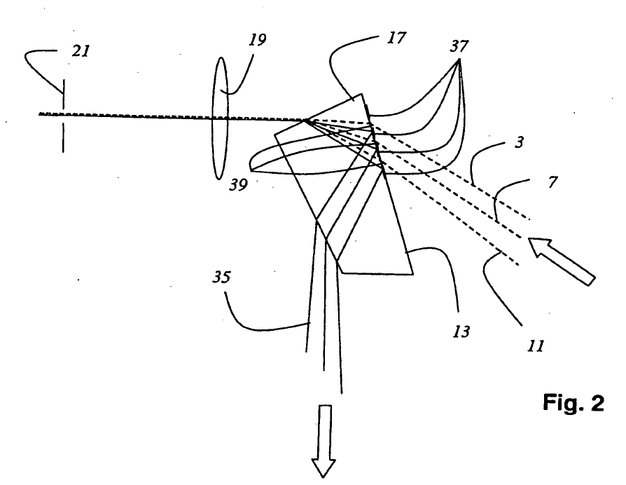

FIG. 2 is a detailed view of a scanning microscope of the invention,

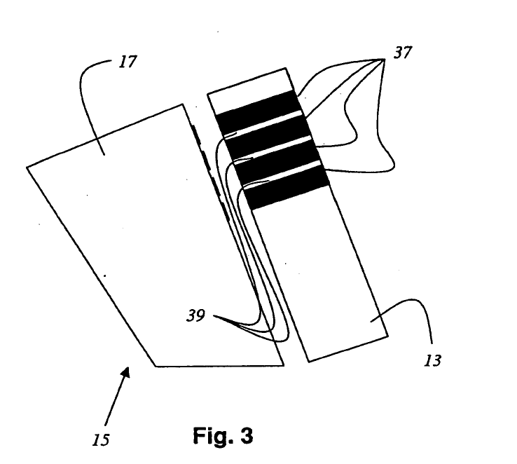

FIG. 3 is a detailed view of a spectral splitter component, and

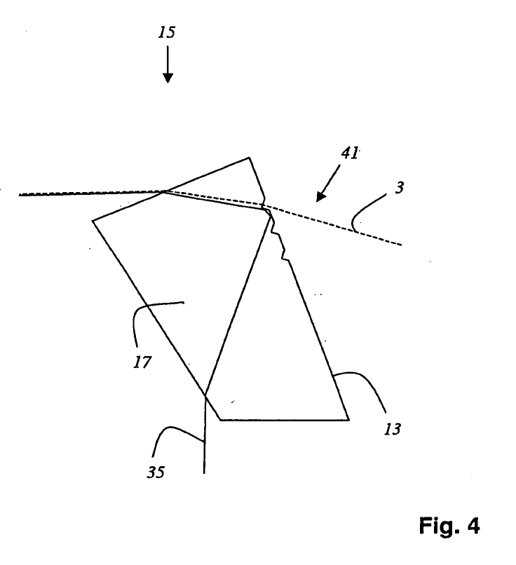

FIG. 4 is a detailed view of another spectral splitter component.

FIG. 1 is a scanning microscope with a first light source 1 emitting a first illumination light beam 3 having a wavelength of 488 nm and with a second light source 5 emitting a second illumination light beam 7 having a wavelength of 560 nm and with a third light source 9 emitting a third illumination light beam 11 having a wavelength of 633 nm. Illumination light beams 3, 7 and 11 (indicated by broken lines) strike the partly coated boundary surface 13 of the spectral splitter component 15 configured as a prism 17. Boundary surface 13 of prism 17 has reflecting and nonreflecting regions. Illumination light beams 3, 7 and 11 strike the nonreflecting regions between the reflecting regions so that the illumination light beams 3, 7 and 11 are transmitted into the prism and after emerging through another boundary surface of the prism and after passing field lens 19 are collinearly combined by pinhole 21 to reach beam deflection unit 23 which contains a cardanically suspended scanning mirror 25. Beam deflection unit 23 guides the collinearly combined illumination light beams 3, 7 and 11 through scanning lens 27, tube lens 29 and objective 31 and then through or over sample 33. Detection light 35 coming from the sample proceeds along the same light path, namely through objective 31, tube lens 29, scanning lens 27 and via beam deflection unit 23 back to pinhole 21, passes through it and after proceeding through field lens 19 is spatially spectrally split by prism 17. When passing through prism 17, the detection light is internally reflected by the reflectively coated parts of boundary surface 13 and as a spatially spectrally split beam leaves prism 17 through a third boundary surface to arrive at the detectors which are not shown.

FIG. 2 is a detailed view of the scanning microscope of the invention represented in FIG. 1. Boundary surface 13 of the prism has reflecting regions 37 where the detection light is internally reflected, and antireflectively coated regions 39 through which the illumination light beams 3, 7 and 11 are coupled in. In this configuration, pinhole 21 serves both as illumination and detection pinhole.

FIG. 3 is a detailed lateral view of the spectral splitter component 15 and of the coated boundary surface 13. Disposed on boundary surface 13 in alternating manner are reflecting regions 37 and antireflectively coated nonreflecting regions 39. The width of the non-reflecting regions 39 is exaggerated relative to the width of the reflecting regions. To prevent large gaps in the detection spectrum, the width of the nonreflecting regions amounts to only fractions of a millimeter, whereas the width of the reflecting regions is in the range of fractions of a centimeter.

FIG. 4 is a detailed view of another spectral splitter component, also in the form of a prism. Boundary surface 13 has a sawtooth-like structure 41. In this variant, the detection light is totally internally reflected whereas the illumination light passes through boundary surface 13 at sites where because of the sawtooth structure there is no the limiting angle of total reflection.

The invention was described with reference to a particular exemplary embodiment. It is selfevident, however, that modifications and changes can be made without thereby leaving the range of protection of the following claims.

### LIST OF REFERENCE NUMERALS

1. first light source
3. first illumination light beam
5. second light source
7. second illumination light beam
9. third light source
11. third illumination light beam
13 boundary surface
15. spectral splitter component
17. prism
19. field lens
21. pinhole
23. beam deflection unit
25. scanning mirror
27. scanning lens
29. tube lens
31. objective
33. sample
35. detection light
37. reflecting regions
39. antireflectively coated regions
41. sawtooth structure

1. A scanning microscope comprising at least one light source defining an illumination beam path and a spectral detector for detecting a detection light coming from a sample and defining a detection beam path, and spectral splitter means for separating, the illumination beam and the detection beam.

2. The scanning microscope as defined in claim 1, wherein the spectral splitter means comprises a grating.

3. The scanning microscope as defined in claim 1, wherein the spectral splitter means comprises a prism.

4. The scanning microscope as defined in claim 3, wherein said prism comprises a boundary surface reflectively coated at least in part.

5. The scanning microscope as defined in claim 4, wherein said boundary surface reflects internally detection light or illumination light.

6. The scanning microscope as defined in claim 5, wherein said boundary surface transmits the illumination light or the detection light.

7. The scanning microscope as defined in claim 6, wherein said boundary surface comprises reflectively coated and non-reflectively coated parts and detection light strikes the reflectively coated parts of the boundary surface and the illumination light strikes the non-reflectively coated parts of the boundary surface.

8. The scanning microscope as defined in claim 6, wherein said boundary surface comprises reflectively coated and non-reflectively coated parts and illumination light strikes the reflectively coated parts of the boundary surface and detection light strikes the non-reflectively coated parts of the boundary surface.

9. The scanning microscope as defined in claim 4, wherein said boundary surface comprises reflectively coated and non-reflectively coated parts, said non-reflectively coated parts of the boundary surface having an antireflective coating.

10. The scanning microscope as defined in claim 4, wherein said boundary surface comprises reflectively coated and non-reflectively coated parts, said reflectively coated parts and non-reflectively coated parts being disposed alternately next to each other.

11. The scanning microscope as defined in claim 4, wherein the boundary surface is covered with a dichroic coating.

12. The scanning microscope as defined in claim 4, wherein said boundary surface of the prism is structured in stepped or sawtooth form.

13. The scanning microscope as defined in claim 4, wherein the boundary surface totally reflects the detection light or the illumination light internally.

14. The scanning microscope as defined in claim 4, wherein regions of the boundary surface with total internal reflection and regions not showing total internal reflection are disposed side-by-side.

15. The scanning microscope as defined in claim 3, wherein said boundary surface is provided with segments made of a material the refractive index of which is different from that of the prism.

16. The scanning microscope as defined in claim 1, wherein the microscope is a confocal scanning microscope.
